(19) United States
(12) Patent Application Publication
(10) Pub. No.: US 2012/0296867 A1
(43) Pub. Date: Nov. 22, 2012

(54) METHOD AND SYSTEM FOR FILE SYNCHRONIZATION

(75) Inventor: Sven Berkvens-Matthijsse, Eindhoven (NL)

(73) Assignee: IPHION B.V., Eindhoven (NL)

(21) Appl. No.: 13/450,284

(22) Filed: Apr. 18, 2012

(30) Foreign Application Priority Data
Apr. 19, 2011 (NL) 2006626

(51) Int. Cl. G06F 17/30

(52) U.S. Cl. 707/610; 707/E17.01

(57) ABSTRACT

Method and systems for synchronizing files on a target storage medium with files on a source storage medium, where the target storage medium is divided into pages of a given size. If a file on the target storage medium has been modified compared to a corresponding file on the source storage medium, the page(s) involved are marked as free and all files that are stored in whole or in part on the page(s) receive a status of “to be copied to target storage medium”. For each page of the target storage medium that is marked as free, a selection is made from the files having such a status by repeatedly selecting the relatively largest file not yet selected that can be accommodated on the page, taking into account earlier files selected for the page, and for each page, copying the selection for that page to the target storage medium.

### PRIORITY CLAIM

This non-provisional application claims priority from Dutch Patent Application Serial No. 2006626, filed 19 Apr. 2011, and titled Method and System for File Synchronization, presently pending, which is incorporated herein by reference in its entirety and for all its teachings and disclosures.

### BACKGROUND OF THE INVENTION

Programmable devices such as phones or set-top boxes are omnipresent in today's society. While these devices in principle are as versatile as ordinary desktop computers or laptops, they are usually designed for one specific task (like processing television signals or facilitating television) and these devices are adapted technically to this task both form-wise and hardware-wise.

These devices, but increasingly also ordinary laptops, often use flash memories. This type of non-volatile memory is a species of Electrically erasable programmable read-only memory (EEPROM). Flash memory is characterized by the property that one programming action does not write or erase single bytes but groups of bytes. These groups are called pages, and a flash memory is typically divided in a number of pages of given size. Two main types exist: NOR- and NAND-flash, whose distinction arises from the structure of the interconnections between memory cells.

Key advantages of flash memory are the fast reading speed and the low vulnerability against shocks, compared to traditional hard disks. An important disadvantage of flash memory is that erasing pages (sometimes also called blocks or sectors) is only possible for a limited number of times before the integrity of the page is compromised. Products of flash memory give different warranties on this matter, a warranty of 10.000 erasure operations being common for the typical relatively cheap flash memory used in consumer electronics. Flash memory that can survive 100.000 erasure operations also exists but is more expensive and is not used quite as often in such devices.

Programmable devices like consumer electronics use a great deal of software, usually quite complex, which is changed from time to time to address bugs or add improvements. Making such a change or upgrade to software stored in flash memory requires the erasure of the relevant pages on the flash memory, which due to the above-mentioned limitation requires that the number of erasure operations is minimized.

The same applies in other situations where the content of a flash memory needs to be synchronized with the content of an external memory, for example when synchronizing music files on the flash memory of a portable music player and the content of a hard disk in a laptop.

US 2010/070469 discloses a synchronization framework that provides improved synchronization granularity in a process of synchronizing pages of memory with a hard disk in order to maintain the integrity of the computer system. Certain memory pages are filtered out when synchronizing, based on certain criteria such as the fact that a memory page relates to a particular application or that the file to which the memory page relates is larger than a given size. In one embodiment memory pages are synchronized if they correspond to files that are a particular size (e.g., greater than 2 GB). This framework is able to synchronize a subset of the memory pages without having to synchronize all active memory pages, thus taking a shorter amount of time and alleviating input/output bottlenecks.

### SUMMARY OF THE INVENTION

One aim of the invention is to offer a method and system for synchronizing files on a target storage medium with files on a source storage medium, where the target storage medium is divided into pages of a given size with the property that the changing of data on the target storage medium can be done only at the page level, in which the number of pages to be changed is reduced.

To this end, the invention provides a method as claimed in claim 1 and a system as claimed in claim 7. The method and the system work from a source storage medium such as a hard disk from which data is to be synchronized with a target storage medium. The target storage medium is a flash memory with the aforementioned restriction on erasing by the page.

According to the invention the number of pages to be changed is limited by first determining for each file on the target storage medium if it has been modified compared to the corresponding file on the source storage medium. The term ‘modification’ normally refers to changes in the content of the file, but may in this invention also refer to the situation where the corresponding file has been deleted from the source storage medium.

In case the file on the target storage medium has been changed, the page or pages on which the file resides are marked as free. All files on this page or these pages are assigned a status of “to be copied to target storage medium”. No actual write or erasure operation takes place yet, the marking and status assignment are purely administrative in nature.

Next, for each page of the target storage medium that is marked as free, a selection is made from the files having a status of “to be copied to target storage medium”. This selection is made by repeatedly selecting the relatively largest file not yet selected from the files having a status of “to be copied to target storage medium” that can be accommodated on the page, taking into account earlier files selected for the page. Once the combined size of the selected files is equal to the size of the page, or the selection of a further file would cause the combined size to exceed the size of the page, the final step is to copy the selected files to the target storage medium in the order of their selection.

Advantage of this method is that pages whose files have not been modified, remain unchanged, thus avoiding an erasure operation. Another advantage is that pages that have been marked as free but are not reused during the final copying step are not touched, again avoiding an erasure operation. And a third advantage is that the making of the selection achieves an efficient usage of the pages on the target storage medium.

In an embodiment the case that the size of a particular file with the status of “to be copied to target storage medium” is more than the given size is addressed. In this case the particular file is selected only if sequentially next on the target storage medium enough consecutive pages are available that are marked as free. Depending on the properties of the filesystem of the target storage medium it may be technically necessary to store files that require more than one page of storage space in consecutive pages. Some flash filesystems do not have this requirement. Still, it may be efficient to store large files in this manner.

In a further embodiment the step of marking pages as free and assigning files the status of “to be copied” is performed in a modified way in case the file on the target storage medium has no corresponding file on the source storage medium. More precisely, in this case this file is not assigned the status of “to be copied to target storage medium”. This addresses the situation where the file has been deleted on the source storage medium. The page in question on the target storage medium is marked as free. Other files on this page receive the status of “to be copied to target storage medium”, but of course the file that has been deleted on the source storage medium does not.

In a further embodiment the target storage medium and source storage medium are located in different devices. In this embodiment step 4 is carried out in the device in which the target storage medium is located after receipt of copying information comprising indications of which files have the status of “to be copied to target storage medium”. This device would typically be a server, having access to information on the files present on target storage media in multiple client devices. A server can efficiently carry out the operations necessary for determining differences and marking pages, and then transmit the copying information to the client devices, which in turn can carry them out directly.

With this embodiment it is avoided that client devices themselves need to compare source and target files, which for these typically underpowered devices is a time- and capacity-consuming operation. Moreover, all relevant files from the source storage medium would have to be transmitted to the client devices to allow them to make the comparison.

In a further embodiment prior to the step of copying an intermediate step is made in which for each page on the target storage medium the differences, if any, with the files with a status of “to be copied to target storage medium” selected for that page are determined, and the copying information further comprises these differences. This saves data transmission capacity because the differences can be transmitted instead of the entire content of the page.

A further embodiment deals with the case that a to be copied part of a file is present on a different location on the target storage medium. In that case the copying information additionally comprises this different location instead of the to be copied part, which allows in step 4 the part to be copied from the different location instead of the source medium. This saves a data transmission from source to target storage medium. This location does not necessarily have to be the location of the file in question. Information from one file may be present in another file, because fragments of files can be identical.

### BRIEF DESCRIPTION OF THE FIGURES

The invention will now be elaborated upon with reference to the figures, in which

FIG. 1 schematically shows a device with a source storage medium and a target storage medium;

FIG. 2a illustrates an example of content on the source and target storage media in a situation where differences exist between the files on the media;

FIG. 2b illustrates an example of content on the target storage medium after the differences have been determined and processed;

FIG. 3 shows a flowchart illustrating the method of the invention;

FIG. 4 elaborates upon the copying step of FIG. 3; and

FIG. 5 schematically shows a variation of FIG. 1 in which the target storage medium and source storage medium are located in different devices.

In the figures, same reference numbers indicate same or similar features.

### DESCRIPTION OF CERTAIN EMBODIMENTS

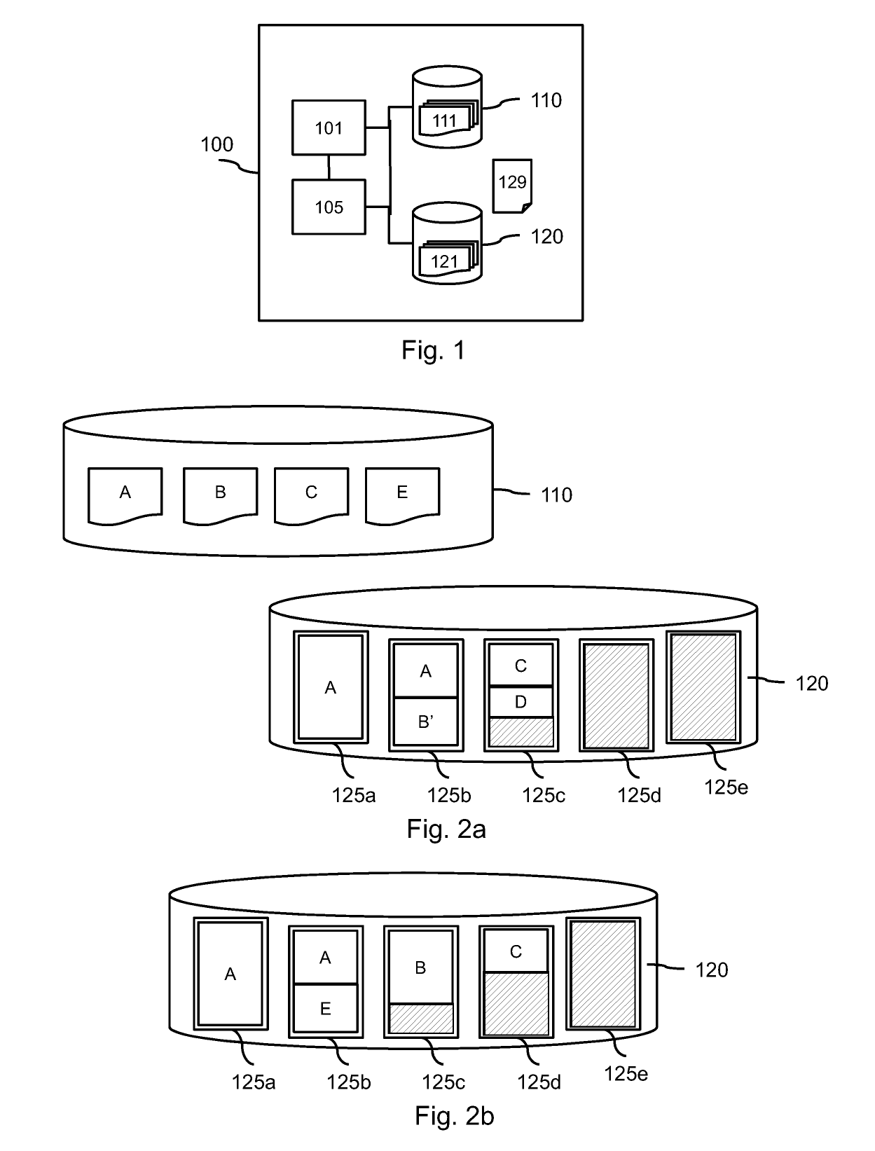

FIG. 1 schematically shows a device 100 with a source storage medium 110 and a target storage medium 120. Both media 110, 120 comprise files 111, 121 which represent logical collections of data. Files can comprise any type of data, ranging from e.g. text, music or movies to software that can be executed by the device 100 or a different device.

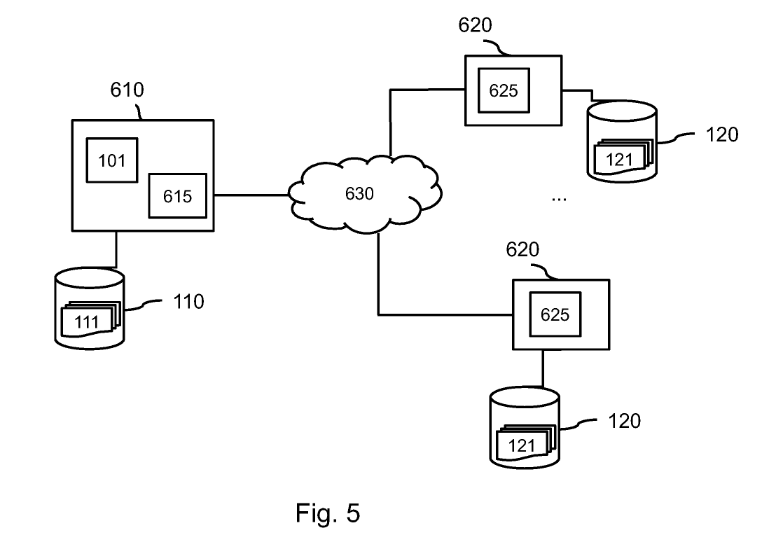

The target storage medium 120 can be for instance a USB memory that cooperates with a personal computer or laptop, in which case the source storage medium 110 would be the internal hard disk of this computer or laptop. It is also possible that the target storage medium 120 resides in a device different from the source storage medium 110. This variation is discussed below with reference to FIG. 5.

The target storage medium 120 is a flash memory, with the property that data stored thereon can be changed only at the level of individual pages. The properties of the source storage medium 110 are not relevant. In practice the source storage medium 110 will often be a hard disk but this is not required.

To facilitate the management of files on the target storage medium 110 the device 100 has access to a file allocation table 129 which for a file 121 records on which location(s) on a page or pages the file 121 starts and ends. With this file allocation table 129 a file can be ‘erased’ by removing the recorded location(s) without having to actually erasing the page(s) in question. The file 121 can be moved by copying the data to a different page and updating the page 129 to refer to the new location, again avoiding actual erasure of the old page(s).

It is to be noted that this file allocation table 129 is not necessarily in the format prescribed by the well-known FAT standard from Microsoft, or other logical file allocation tables or structures. On flash memories the actual division of files over pages is independent from the logical division according to the FAT or other filesystem. With this approach it is possible to move files in while or in part without changing the logical division, which may be necessary for example when a page of the flash memory is likely to become corrupt or damages.

The device 100 comprises a difference detector 101 which for each file 121 on the target storage medium 110 checks if there are any differences compared to the corresponding file 111 on the source storage medium 110. Comparing and determining differences by itself is a well-known technique. The inventor recommends to use a software program such as ‘bsdiff’, widely available for free on the internet. This program not only reports if a file is different from another file, but also produces an indication of the actual differences, allowing these differences to be easily propagated to the file on the target storage medium 110.

Of course many alternative techniques are available. If the type of data comprised in the files is known, it may be more useful to use a difference detection algorithm specially tailored to this type of data. The bsdiff software program is designed to compare binary data in general. For images or textual data different algorithms may be more suited. The skilled person can use routine labor to find an appropriate algorithm

It may be sufficient to work with only an indication that two files 111, 121 differ. When files have version indications, it may be enough to compare only the version indications to conclude that a file has been changed based on the fact that the version indications differ.

If the difference detector 101 detects that a file 121 has been changed compared to the corresponding file 111, the page or pages on which the file 121 resides is/are marked as free. All files on this page or these pages are assigned a status of “to be copied to target storage medium”. No actual write or erasure operation takes place yet, the marking and status assignment are purely administrative in nature.

In addition the difference detector 101 verifies whether any files are present on the source storage medium 110 that are not present on the target storage medium 110. Such a file 111 is also assigned the status of “to be copied to target storage medium”.

After all files have been processed in this manner, the difference detector 101 provides administrative information about the files having a status of “to be copied to target storage medium” to a copying module 105. The copying module 105 subsequently copies all files from the source storage medium 110 having a status of “to be copied to target storage medium” to the target storage medium 110. Due to the properties of the target storage medium 110 this must be done to pages being marked as free. These pages must be erased before files can be written thereto.

FIG. 2a illustrates an example of content on storage media 110, 120 in a situation where differences exist between the files on the media 110, 120. As shown source storage medium 110 contains files A, B, C, D and E. Target storage medium 120 is divided into pages 125a, 125b, 125c, 125d and 125e and comprises files A, B′, C and D. File A is on pages 125a and 125b. File B′ is on page 125b, after the last part of file A.

Files C and D are present on page 125c. Pages 125d and 125e are entirely free. Any free space on a page is indicated by cross hatching.

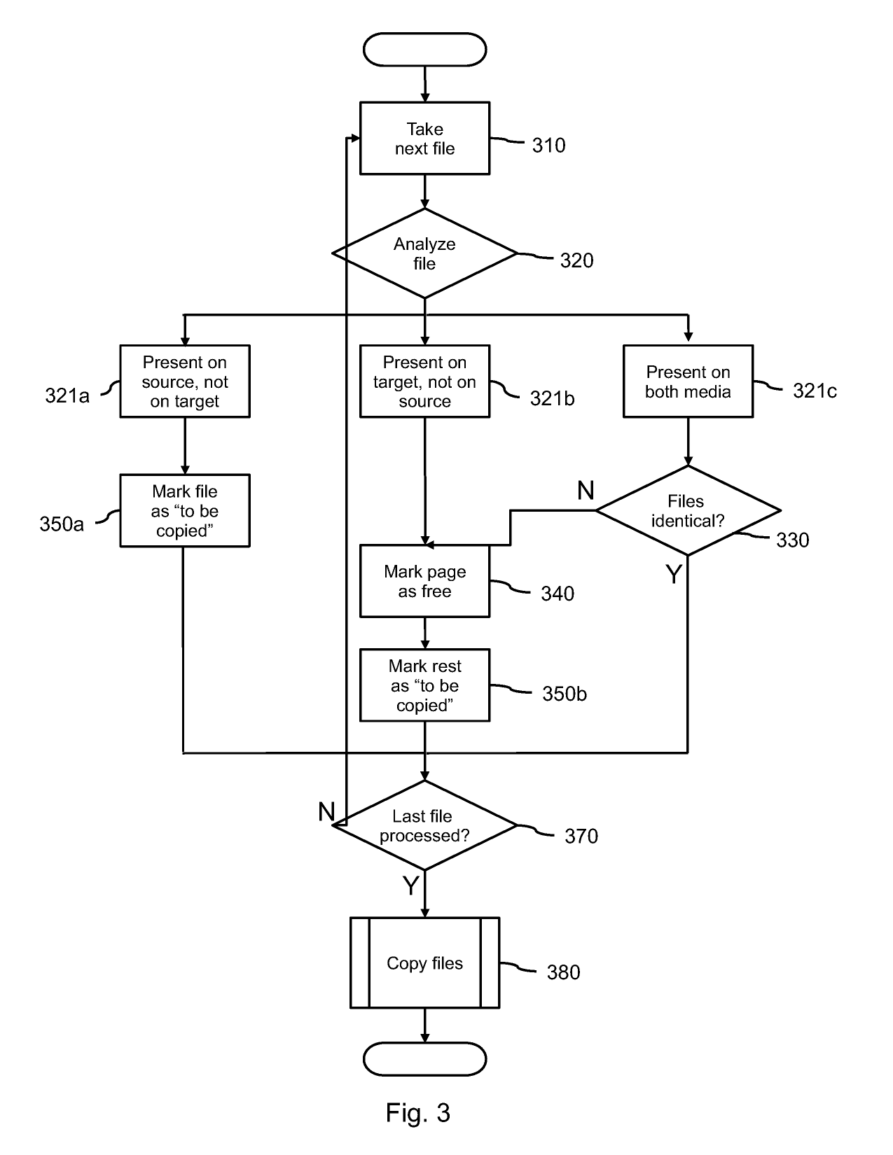

FIG. 2b illustrates an example of content on the target storage medium 110 after the differences have been determined and processed. The method of the invention is discussed below with reference to the flow chart of FIG. 3.

In steps 310 and 370 each file present on one or both of the media 110, 120 is checked by the difference detector 101. In the example the difference detector 101 thus checks each of the five files A, B, C, D and E. Step 320 comprises analyzing on which media 110, 120 the file 120 resides. There are three possibilities:
321a) The file does reside on the source storage medium 110 but not on the target storage medium 110.
321b) The file does reside on the target storage medium 110 but not on the source storage medium 110.
321c) The file resides on both media 110, 120.

In option 321a the file is new and must be copied to the target storage medium 110. It therefore is marked as “to be copied to target storage medium” in step 350a.

In option 321b the file apparently has been deleted from the source storage medium 110, and therefore must also be deleted from the target storage medium 110. In step 340 then the page on which the file resides is marked as free. All files on this page are marked as “to be copied to the target storage medium” in step 350b. Note that a file could be so marked while in a later stage it may be discovered that this file does not have to be copied after all, because it is not in fact present on the source storage medium 110. The difference detector 101 then changes the marking.

In option 321c the file is present on both media 110,120. Step 330 now verifies whether the file on the target storage medium 110 is different from the version of the file on the source storage medium 110. If this is the case, steps 340 and 350b are carried out after all. If both versions are the same, the flowchart proceeds to step 370 to determine if a next file is to be checked.

In the example of FIGS. 2a and 2b the difference detector 101 will, in accordance with this flowchart, detect that the files A and C have not been modified, that file B′ is a modified version of file B, that file D is not present on the source storage medium 110 but present on the target storage medium 110, and that file E is present on the source storage medium 110 but not present on the target storage medium 110.

Based on these findings the difference detector 101 will register the following information:

File B has been modified and thus receives the status “to be copied to the target storage medium”;

Page 125b is marked as free because file B resides on this page;

File A receives the status “to be copied to the target storage medium” because it partially resides on page 125b;

Page 125a is marked as free because file A partially resides on this page and has received the status “to be copied to the target storage medium”;

Page 125c is marked as free because file D has no corresponding file on the source storage medium 110, but file D does not receive the status “to be copied to the target storage medium”;

File C receives the status “to be copied to the target storage medium” because it is present on page 125c;

File E receives the status “to be copied to the target storage medium” because it is not present on any page on the target storage medium 110 and thus is seen as “different” from all files there.

Page 125d is not marked as free, so that no further action on this page is necessary. Optionally the difference detector 101 may register this fact.

An alternative to marking page 125a as free is to keep this page as in use and to only copy those parts of file A which are on pages marked as free for other reasons.

The difference detector 101 will now instruct the copying module 105 to mark as free pages 125a, 125b and 125c and to copy files A, B, C and E from the source storage medium 110 to the target storage medium 110. The copying module 105 in step 380 carries out these actions, thus synchronizing the content of the target storage medium 110 with the content of the source storage medium 110, as shown in FIG. 2b.

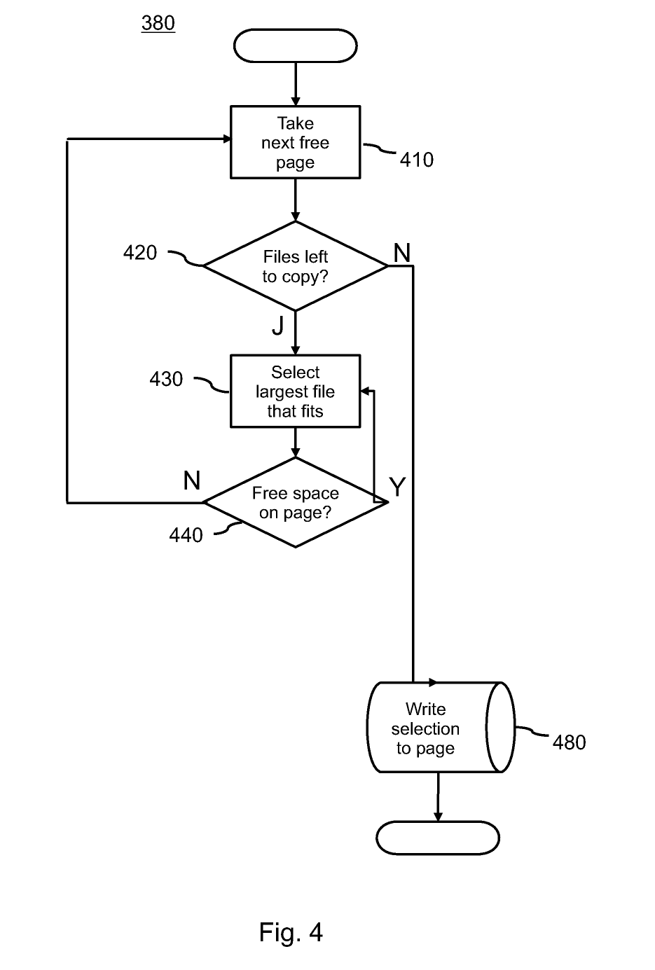

FIG. 4 elaborates on copying step 380. In this step many advantageous embodiments are possible to efficiently use the room available. In the invention, the copying step 380 examines every page on the target storage medium 110 that is marked as free and makes a selection for that page from the files having a status of “to be copied to target storage medium”. This selection is made by repeatedly selecting the relatively largest file not yet selected from the files having a status of “to be copied to target storage medium” that can be accommodated on the page, taking into account earlier files selected for the page.

In step 410 page for page the copying step is performed. Step 420 checks if any files have not yet been selected. If no such files exist, in step 480 the selection for each page is actually copied to that page. If any files are left to be selected for copying, then step 430 selects the largest file that can be accommodated on the page. Step 440 verifies whether after this selection any further file would fit in the remaining free space, and causes step 430 to repeat itself if so. If no or insufficient free space is available, then in step 410 the next page is examined.

In the example all pages marked as free are examined, namely pages 125a, 125b, 125c and 125e. For each page in steps 420, 430, 440 the largest file is selected that would fit on the page in question. This results in a selection for page 125a that comprises the first part of file A, for page 125b a selection comprising the remainder of file B and file E in its entirety, for page 125c a selection comprising only file B′ and for page 125d a selection that comprises only file C. For page 125e no selection is made because all files have already been accommodated.

After the selections have been made, the selected files for each page are written in step 480 to the page in question on the target storage medium 110. Writing occurs per page as this is a technical requirement for flash memories. Often this type of writing requires an erasure operation to occur first. After copying the files to a page the file allocation table 129 must be adapted to include for each copied file a reference to the page.

Special attention is needed if files are larger than a single page, such as file A in the example. Such files may be treated as multiple sub-files, all except one of which are exactly the size of a page and the last sub-file is exactly the size of the remainder. With this approach each sub-file can be copied separately to a free page with sufficient space. This however requires support in the format of the file allocation table 129.

Preferably such a large file is written to a number of pages that are sequentially next to each other on the target storage medium. This requires that enough consecutive pages are available that are marked as free to accommodate the large file. In some filesystems this approach is the only option.

In the example file A is selected first, as it is the largest file. On the target storage medium 110 pages 125a and 125b are available as free. These pages suffice to store file A. The first part of file A is the size of page 125a so this part can be written to page 125a directly.

The second part of file A occupies a part of page 125b, but page 125b has more free space. Therefore now the largest file is chosen from the remaining files B, C and E. Assume this is E. The sum of the size of the second part of file A and the size of file E is larger than both B and C, so that no more files can be added to the selection for page 125b. The selection comprising the second part of file A as well as file E is now written to page 125b.

For page 125c now the largest of files B and C is selected, assume this is B. When C would not fit in the empty space remaining thereafter, the selection for page 125c is complete and file B is written to page 125c. File C then has to be written to page 125e, the next available free page. However if file C does fit in the remaining empty space on page 125c, then files B and C are jointly written to page 125c and page 125e would remain empty.

The number of copying actions can be reduced by performing an optional verification step (not shown) prior to copying step 480. This verification step compares the selection for a page with the actual content of that page. If the selection and the content are identical, the copying is skipped because copying would be unnecessary. In the example no information would be copied to page 125a, because its original content is identical to the selection made for it, namely the first part of file A. Page 125a would now only be marked as in use, and the file allocation table 129 would be adapted to (again) record the fact that file A is present on this page 125a.

FIG. 5 schematically shows a variation of FIG. 1 in which the target storage medium 120 and source storage medium 110 are located in different devices. The situation shown in FIG. 5 is a typical client/server situation where server 610 communicates with one or more client devices 620 over a network 630 such as the Internet. Each client device 620 comprises a target storage medium 110, while the server 610 comprises the source storage medium 110. The server 610 now has the responsibility of ensuring that the content of the target storage medium 110 in each client device 620 is synchronized with the source storage medium 110.

The difference detector 101 is present in the server 610 and analyzes for each file 121 on the target storage medium 110 whether it differs from the corresponding file 111 on the source storage medium 110 as explained above. Client device 620 could have provided the necessary information, for example as an overview of files, pages and the like, but difference detector 101 could also work with information already present at the server 610. For example server 610 could record which data has been sent to client device 620 earlier, and use the recorded data to have the difference detector 101 carry out the analysis. Difference detector 101 could also, as explained above, use the version numbers of files.

In practice it is possible that the contents of the target storage media in different client devices 620 differ, for example because a prior synchronization operation was not or not successfully carried out. In that case the difference detector 101 must separately verify the files for each client device 610 and initiate the copying process.

After all files have been analyzed in the above manner, the difference detector 101 provides administrative information about the files with a status “to be copied to the target storage medium” to a copying module 615. Copying module 615 resembles copying module 105 but because the target storage medium 110 is in another device than the source storage medium 110, some differences exist. In practice the copying module 615 would work together with a corresponding copying module 625 in the client device 620, where the copying module 615 would provide copying information to copying module 625, which information would among others indicate which files have the status “to be copied to the target storage medium”. Copying module 625 would then carry out the actual copying.

In a first embodiment all files having the status “to be copied to the target storage medium” would be transmitted to the client device 620, together with information about which pages to mark as free. In that case copying module 615 would be no more than a conduit to copying module 625. Copying modules 615 and 625 could also work together in various ways to reduce the amount of information to be transmitted and the number of changes to be carried out.

In a preferred embodiment prior to the transmission step an intermediate step is carried out in which for each page on the target storage medium 120 the differences, if any, with the files with a status of “to be copied to target storage medium” selected for that page are determined, and the copying information further comprises these differences. In this embodiment the files can be compared with the already-mentioned ‘bsdiff’ software program to determine the differences at the page level.

In another preferred embodiment prior to the transmission step first a verification is made if a to be copied part of a file is present on a different location on the target storage medium 120. In that case, the copying information only comprises the location of this part instead of the part itself. Copying module 625 would then during the actual copying copy this part from the indicated location. This way copying module 615 does not have to transmit this part.

In the example of FIG. 2 for example file C would not be transmitted, but instead only the instruction to write the data of file C to page 125d from its original location on page 125c. For file A comparable instructions could be included. However note that page 125a remains unchanged, so the copying module 615 could merely indicate that the marking of page 125a as free must be undone.

The second part of file A does require a copying action, because page 125b additionally must include part E. The second part of file A is already present on page 125b. The instruction can be given to read this part to a working memory, add file E to that and write the combination to page 125b. Due to the nature of flash memories it is not possible to just add file E to the existing content of page 125b. File E of course must be transmitted in its entirety, as this file is not present at all on any page on the target storage medium 110.

For the changed file B a determination can be made which parts of file B′ on the target storage medium 110 are identical to the corresponding parts of file B on the source storage medium 110. These parts then do not have to be transmitted. It suffices to transmit copying information identifying these parts and their locations. In addition it may be the case that information to be added to file B′ is already present elsewhere in a file, for example file A or C. The copying module 615 first verifies if this is the case. It is very well possible that files have partially identical content. For example programs (firmware) for the client device 620 will often use the same standard libraries, and data files can contain overlapping information. By copying this information from one file to another a transmission is avoided.

If in this embodiment copying module 625 receives the copying information, the copying module 625 will then copy the parts in question from the indicated location to the desired location. The copying information can be obtained with the bsdiff software package, although other solutions also exist.

These two advantageous embodiments can be combined. By determining the differences at the page level and avoiding transmission already present parts of files, an even greater saving is achieved.

The above provides a description of several useful embodiments that serve to illustrate and describe the invention. The description is not intended to be an exhaustive description of all possible ways in which the invention can be implemented or used. The skilled person will be able to think of many modifications and variations that still rely on the essential features of the invention as presented in the claims. In addition, well-known methods, procedures, components, and circuits have not been described in detail.

The invention is preferably implemented in a computer program product, i.e. a collection of computer program instructions stored on a computer readable storage device for execution by a computer. The instructions of the present invention may be in any interpretable or executable code mechanism, including but not limited to scripts, interpretable programs, dynamic link libraries (DLLs) or Java classes. The instructions can be provided as complete executable programs, as modifications to existing programs or extensions (“plugins”) for existing programs. Moreover, parts of the processing of the present invention may be distributed over multiple computers or processors for better performance, reliability, and/or cost.

Machine-readable storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. To this end one may connect a server system comprising the storage medium discussed above to a network, and arrange this server for allowing the instructions to be downloaded to client systems connected directly or indirectly to the network. The computer program product may be present in the device 100, 610, 620 or be offered for such download from a server so as to be added to the device 100, 610, 620 later.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

1. A method of synchronizing files on a target storage medium with files on a source storage medium, where the target storage medium is divided into pages of a given size with the property that the changing of data on the target storage medium can be done only at the page level, which method comprises:
1) determining for each file on the target storage medium if the file has been modified compared to a corresponding file on the source storage medium,
2) if this is the case,
marking the page or pages on the target storage medium on which the file is stored as free and
assigning all files that are stored in whole or in part on this page or these pages a status of “to be copied to target storage medium”,
3) for each page of the target storage medium that is marked as free, making a selection from the files having a status of “to be copied to target storage medium”, which selection is made by repeatedly selecting the relatively largest file not yet selected from the files having a status of “to be copied to target storage medium” that can be accommodated on the page, taking into account earlier files selected for the page, and
4) for each page, copying all files with a status of “to be copied to target storage medium” selected for that page to the target storage medium in the order of their selection.

2. The method of claim 1, in which, during step 3, in case the size of a particular file with the status of “to be copied to target storage medium” is more than the given size, the particular file is selected only if sequentially next on the target storage medium enough consecutive pages are available that are marked as free.

3. The method of claim 1, in which step 2 is also performed in case the file on the target storage medium has no corresponding file on the source storage medium, without assigning this file the status of “to be copied to target storage medium”.

4. The method of claim 1, in which the target storage medium and source storage medium are located in different devices, and where step 4 is carried out in the device in which the target storage medium is located after receipt of copying information comprising indications of which files have the status of “to be copied to target storage medium”.

5. The method of claim 4, in which prior to step 4 an intermediate step is made in which for each page on the target storage medium the differences, if any, with the files with a status of “to be copied to target storage medium” selected for that page are determined, and the copying information further comprises these differences.

6. The method of claim 4, in which in case a to be copied part of a file is present on a different location on the target storage medium, the copying information additionally comprises this different location instead of the to be copied part, and step 4 is modified in that the part is not copied from the source medium but instead is copied from the different location.

7. A system for synchronizing files on a target storage medium with files on a source storage medium, where the target storage medium is divided into pages of a given size with the property that the changing of data on the target storage medium can be done only at the page level, which system comprises:
a difference detector configured for determining for each file on the target storage medium if the file has been modified compared to a corresponding file on the source storage medium, and if this is the case,
marking the page or pages on the target storage medium on which the file is stored as free and
assigning all files that are stored in whole or in part on this page or these pages a status of “to be copied to target storage medium”,
the difference detector being additionally configured for each page of the target storage medium that is marked as free, making a selection from the files having a status of “to be copied to target storage medium”, which selection is made by repeatedly selecting the relatively largest file not yet selected from the files having a status of “to be copied to target storage medium” that can be accommodated on the page, taking into account earlier files selected for the page, and
a copying module configured for, for each page, copying all files with a status of “to be copied to target storage medium” selected for that page to the target storage medium in the order of their selection.

8. The system of claim 7, in which the copying module is present in a client device connected to a server device comprising the difference detector.

9. A computer program product comprising machine-readable instructions for causing a processor to execute the method of claim 1.
